(19) United States
(12) Patent Application Publication
(10) Pub. No.: US 2007/0014962 A1
(43) Pub. Date: Jan. 18, 2007

(54) Multi-color paint tablet

(76) Inventor: Kathleen Torrell, Playa Del Rey, CA (US)

Correspondence Address: TOPE-MCKAY & ASSOCIATES, 23852 PACIFIC COAST HIGHWAY #311, MALIBU, CA, 90265, US

(21) Appl. No.: 11/181,696

(22) Filed: Jul. 13, 2005

(51) Int. Cl. B32B 3/02

(52) U.S. Cl. 428/64.1

(57) ABSTRACT

A multi-color dry paint tablet is described. The paint tablet has at least two portions, where a first portion of the paint tablet is formed of a paint having a first color and a second portion of the paint tablet is formed of paint having a second color. A user may add a liquid to either the first or second portions to dissolve the first and second colors respectively to form a paint solution of the first or second colors. Additionally, a user may add a liquid to both the first and second portions simultaneously to mix the first and second colors to form a paint solution having a third color.

### BACKGROUND OF THE INVENTION

(1) Field of Invention

The present invention relates to a paint tablet and, more particularly, to a multi-color, dry and compacted tablet of water-based paint, where a portion of the tablet is one color and another portion of the tablet is another color, such that adding water to the tablet mixes the colors to create a new color.

(2) Description of Related Art

Paints have long been a favorite of both children and adults alike, allowing a user to create signs, artwork, etc. Paints typically come in two forms; oil-based and water-based.

Water-based paints (known as water paints) are typically dry paints that require the addition of water to dissolve the paint into a paint solution. Once dissolved into a paint solution, a user is able to apply the paint to a desired surface.

Traditionally, water paints come in a package with each color separated from the other. In order to mix the paints to form different colors, a user typically applies and mixes paint solutions of different colors on a palette or other surface.

However, in some cases, it may be desirable to use the paint itself as a mixing palette. Thus, a continuing need exists for a water-based paint that allows a user to use the paint itself as a mixing surface.

### SUMMARY OF INVENTION

The present invention relates to a multi-color paint tablet. The paint tablet is a dry paint tablet having at least two portions. A first portion of the paint tablet is formed of a paint having a first color and a second portion of the paint tablet is formed of paint having a second color. A user may add a liquid to either the first or second portions to dissolve the first and second colors respectively. Additionally, a user may add a liquid to both the first and second portions simultaneously to mix the first and second colors to form a paint solution having a third color.

In another aspect, the tablet includes a top portion with a dimple formed in the top portion. The dimple is formed such that both the first and second portions are present within the dimple, thereby allowing a user to place the liquid within the dimple to dissolve and mix both the first and second colors to form the third color.

In another aspect, the first and second colors are primary colors, such that adding a liquid to both the first and second portions mixes the primary colors to form a secondary color.

In yet another aspect, the first and second portions are formed of a water-based paint such that adding water to the paint tablet dissolves the water-based paint.

Finally, as can be appreciated by one skilled in the art, the present invention also comprises methods for forming and using the multi-colored paint tablet described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a perspective-view illustration of a multi-color paint tablet according to the present invention;

FIG. 2 is a perspective-view illustration of a multi-color paint tablet according to the present invention, illustrating the addition of a liquid to form another color;

FIG. 3 is a side-view illustration of a multi-color paint tablet according to the present invention;

FIG. 4 is a top-view illustration of a multi-color paint tablet according to the present invention;

FIG. 5 is a bottom-view illustration of a multi-color paint tablet according to the present invention; and

FIG. 6 is a side-view illustration of a multi-color paint tablet according to the present invention.

### DETAILED DESCRIPTION

The present invention relates to a paint tablet and, more particularly, to a multi-color, dry and compacted tablet of water-based paint, where a portion of the tablet is one color and another portion of the tablet is another color, such that adding water to the tablet mixes the colors to create a new color. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

(1) Detailed Description of Various Aspects of the Multi-Color Paint Tablet

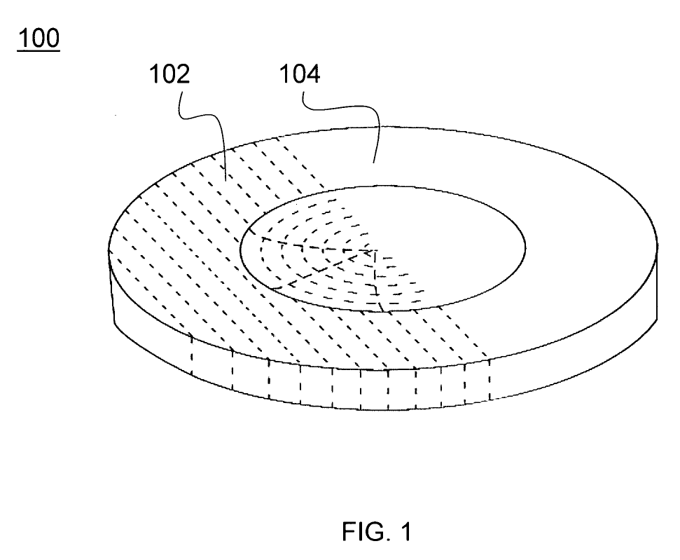

The present invention relates to a multi-color paint tablet. As shown in FIG. 1, the multi-color paint tablet 100 is formed of a dry, water-based paint. The paint tablet includes at least two portions, with a first portion 102 being formed of a paint having first color and a second portion 104 formed of a paint having a second color. As can be appreciated by one skilled in the art, the present invention is not limited to only two colors, and can include several colors. Additionally, although shown as equal portions, the first 102 and second 104 portions can be of unequal sizes. However, it is desirable that the paint tablet 100 include two colors, with each half having a different color.

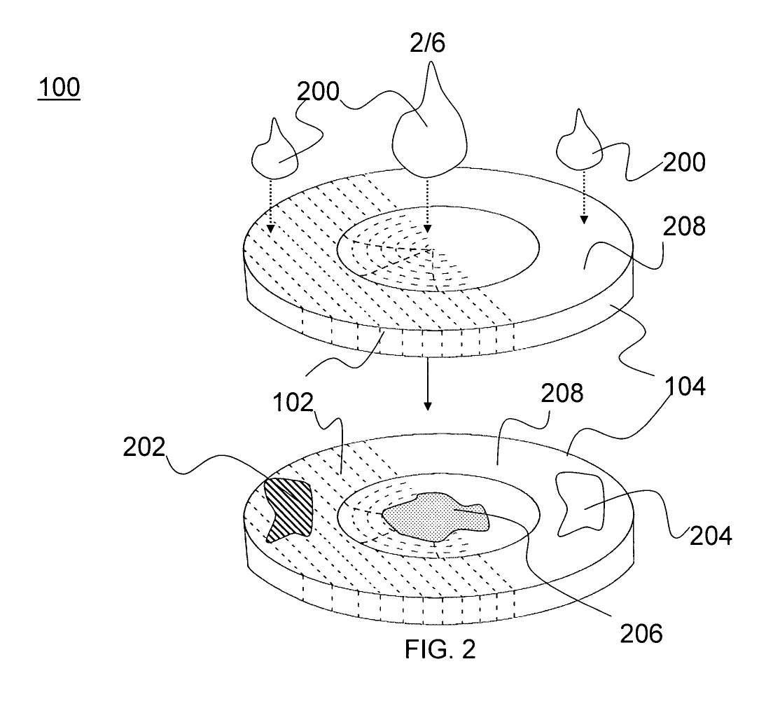

As shown in FIG. 2, by forming the paint tablet 100 of a water-based paint, a user may add a liquid 200 (e.g., water) to either the first 102 or second 104 portions to dissolve the paint and form paint solutions having the first 202 and second 204 colors respectively. Additionally, a user may add a liquid to both the first and second portions simultaneously to mix the first and second colors to form a paint solution having a third color 206.

The first 102 and second 104 portions are formed of any two different colors of paint. As a non-limiting example, the first 102 and second 104 portions are formed of paints having primary colors. In this aspect, adding a liquid to both the first and second portions simultaneously mixes the primary colors to form a secondary color. A primary color is any of a set of colors (as red, yellow, and blue or red, green, and blue) from which all other colors may be derived. It should be noted that although it is desirable to form the first 102 and second portions 104 of primary colors, the present invention is not intended to be limited thereto as the first 102 and second 104 portions may be formed of paints having any color.

In another aspect, the paint tablet 100 includes a top portion 208 with a dimple 210 formed in the top portion 208. The dimple 210 is formed such that both the first 102 and second 104 portions are present within the dimple 210. Using the dimple 210, a user may place the liquid 200 within the dimple 210 to simultaneously dissolve and mix both the first and second colors to form the paint solution the third color 206.

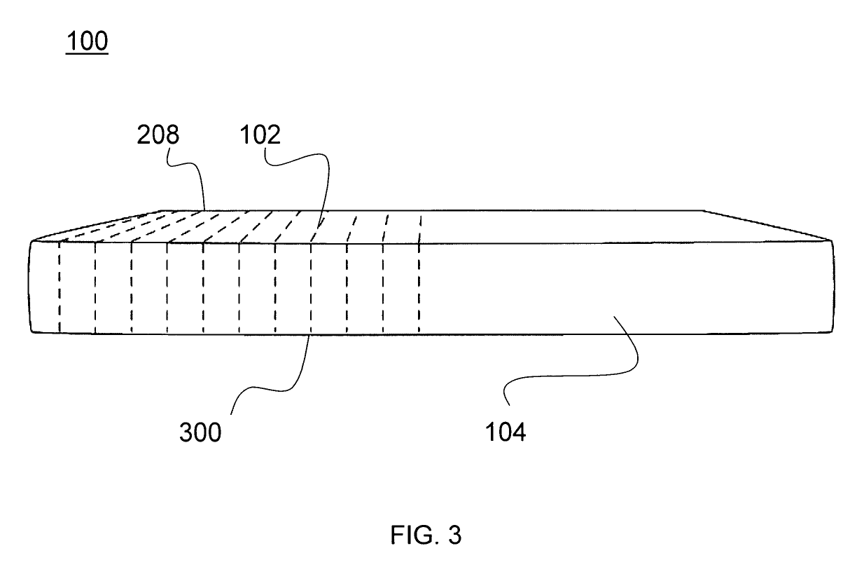

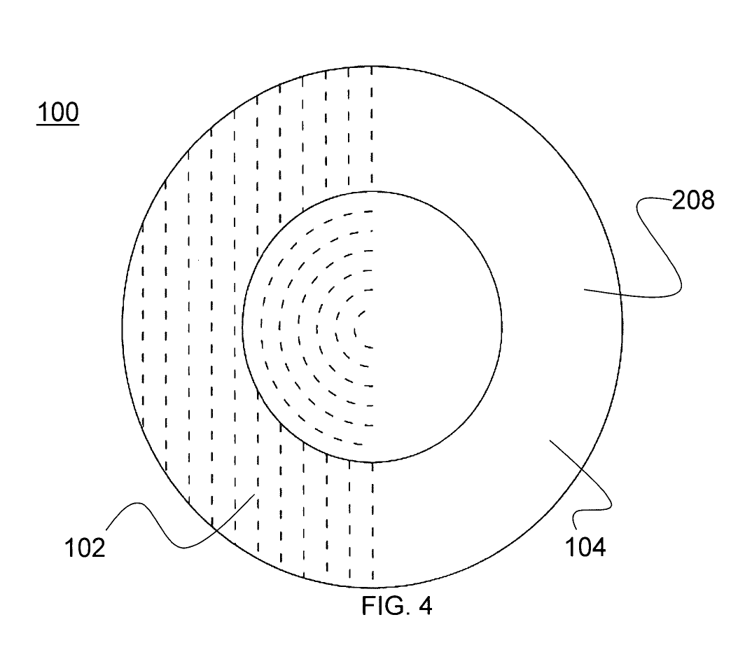

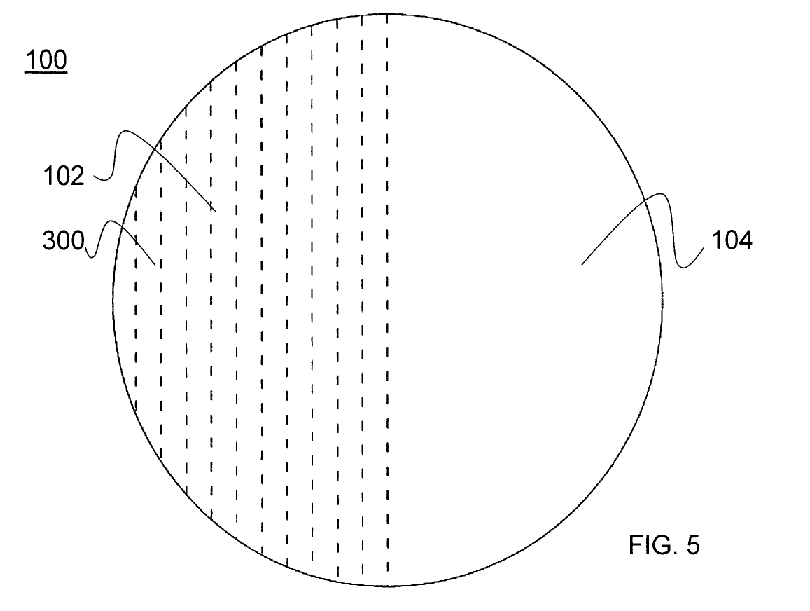

For further illustration, FIGS. 3 through 5 show various viewpoints of the paint tablet 100. FIG. 3 illustrates a side-view; FIG. 4 illustrates a top-view; and FIG. 5 illustrates a bottom-view. As can be seen in FIGS. 3 through 5, the paint tablet 100 is formed such that the paint forming the first 102 and second 104 portions is formed entirely through the paint tablet from the top portion 208 to a bottom portion 300.

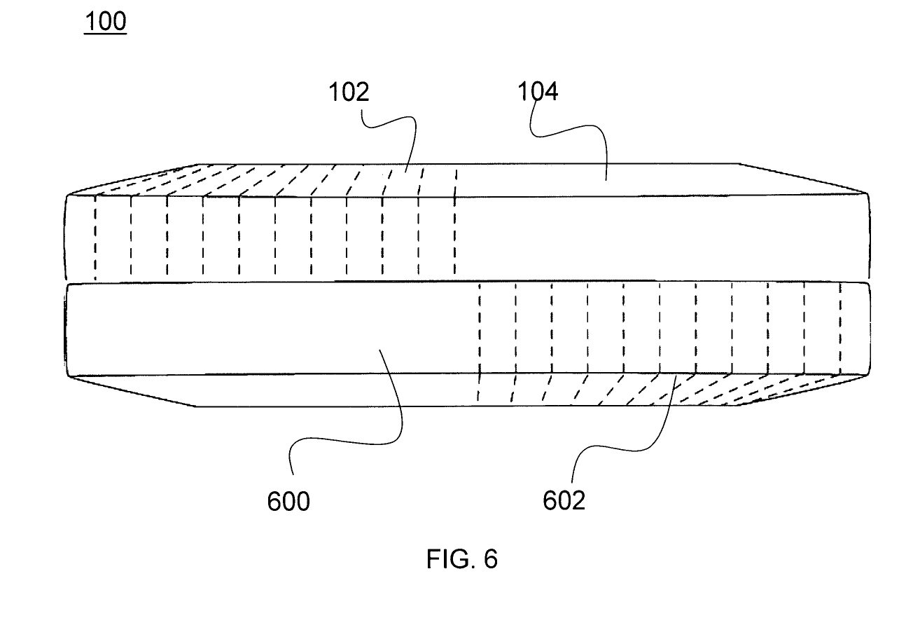

As discussed above, the paint tablet 100 can be formed to have a variety of colors. For example, and as shown in FIG. 6, the paint tablet can be formed such that one side includes the first 102 and second 104 portions, with a second side having a third 600 and fourth 602 portions. In this aspect, the third 600 and fourth 602 portions are formed of paint having a third and fourth color respectively.

As can be appreciated by one skilled in the art, the present invention also comprises methods for forming and using the paint tablet described herein. The method for forming the paint tablet includes acts of forming a dry paint tablet to have at least two portions, where each portion is formed of a paint having a different color. Additional acts comprise forming the paint tablet to have a dimple, be formed of primary colors, and be formed of a water-based paint. The method for using the paint tablet includes acts of selecting the paint tablet described herein and adding a liquid to the paint tablet to form a paint solution.

What is claimed is:

1. A multi-color paint tablet, comprising a dry paint tablet, the paint tablet having at least two portions, where a first portion of the paint tablet is formed of a paint having a first color and a second portion of the paint tablet is formed of paint having a second color, whereby a user may add a liquid to either the first or second portions to dissolve the first and second colors respectively, and where a user may add a liquid to both the first and second portions simultaneously to mix the first and second colors to form a paint solution having a third color.

2. A multi-color paint tablet as set forth in claim 1, wherein the tablet includes a top portion with a dimple formed in the top portion, the dimple formed such that both the first and second portions are present within the dimple, thereby allowing a user to place the liquid within the dimple to dissolve and mix both the first and second colors to form the third color.

3. A multi-color paint tablet as set forth in claim 2, wherein the first and second colors are primary colors, such that adding a liquid to both the first and second portions mixes the primary colors to form a secondary color.

4. A multi-color paint tablet as set forth in claim 3, wherein the first and second portions are formed of a water-based paint such that adding water to the paint tablet dissolves the water-based paint.

5. A multi-color paint tablet as set forth in claim 1, wherein the first and second colors are primary colors, such that adding a liquid to both the first and second portions mixes the primary colors to form a secondary color.

6. A multi-color paint tablet as set forth in claim 1, wherein the first and second portions are formed of a water-based paint such that adding water to the paint tablet dissolves the water-based paint.

7. A method for forming a multi-color paint tablet, the method comprising acts of:
forming a dry paint tablet to have at least two portions, where a first portion of the paint tablet is formed of a paint having a first color and a second portion of the paint tablet is formed of a paint having a second color, whereby a user may add a liquid to either the first or second portions to dissolve the first and second colors respectively, and where a user may add a liquid to both the first and second portions simultaneously to mix the first and second colors to form a paint solution having a third color.

8. A method for forming a multi-color paint tablet as set forth in claim 7, wherein the act of forming a dry paint tablet further comprises an act of forming a dimple in a top portion of the paint tablet, the dimple formed such that both the first and second portions are present within the dimple, thereby allowing a user to place the liquid within the dimple to dissolve and mix both the first and second colors to form the third color.

9. A method for forming a multi-color paint tablet as set forth in claim 8, wherein in the act of forming a dry paint tablet, the first and second colors are formed of primary colors, such that adding a liquid to both the first and second portions mixes the primary colors to form a secondary color.

10. A method for forming a multi-color paint tablet as set forth in claim 9, wherein in the act of forming a dry paint tablet, the first and second portions are formed of a water-based paint such that adding water to the paint tablet dissolves the water-based paint.

11. A method for forming a multi-color paint tablet as set forth in claim 7, wherein in the act of forming a dry paint tablet, the first and second colors are formed of primary colors, such that adding a liquid to both the first and second portions mixes the primary colors to form a secondary color.

12. A method for forming a multi-color paint tablet as set forth in claim 7, wherein in the act of forming a dry paint tablet, the first and second portions are formed of a water-based paint such that adding water to the paint tablet dissolves the water-based paint.

13. A method for using a multi-color paint tablet, the method comprising acts of:
selecting a dry paint tablet having at least two portions, where a first portion of the paint tablet is formed of a paint having a first color and a second portion of the paint tablet is formed of a paint having a second color; and
adding a liquid to the paint tablet such that by adding the liquid to either the first or second portions dissolves the first and second colors respectively, and adding a liquid to both the first and second portions simultaneously mixes the first and second colors to form a paint solution having a third color.

14. A method for using a multi-color paint tablet as set forth in claim 13, wherein the act of selecting a dry paint tablet further comprises an act of selecting a dry paint tablet having a dimple in a top portion of the paint tablet, the dimple formed such that both the first and second portions are present within the dimple, thereby allowing a user to place the liquid within the dimple to dissolve and mix both the first and second colors to form the third color.

15. A method for using a multi-color paint tablet as set forth in claim 14, wherein in the act of selecting a dry paint tablet, the paint tablet is selected such that the first and second colors are formed of primary colors, such that adding a liquid to both the first and second portions mixes the primary colors to form a secondary color.

16. A method for using a multi-color paint tablet as set forth in claim 15, wherein in the act of selecting a dry paint tablet, the paint tablet is selected such that the first and second portions are formed of a water-based paint such that adding water to the paint tablet dissolves the water-based paint.

17. A method for using a multi-color paint tablet as set forth in claim 13, wherein in the act of selecting a dry paint tablet, the paint tablet is selected such that the first and second colors are formed of primary colors, such that adding a liquid to both the first and second portions mixes the primary colors to form a secondary color.

18. A method for using a multi-color paint tablet as set forth in claim 13, wherein in the act of selecting a dry paint tablet, the paint tablet is selected such that the first and second portions are formed of a water-based paint such that adding water to the paint tablet dissolves the water-based paint.
